(19) United States
(12) Patent Application Publication
(10) Pub. No.: US 2017/0168467 A1
(43) Pub. Date: Jun. 15, 2017

(54) METHOD AND DEVICE FOR CONTROLLING INTELLIGENT DEVICE, AND COMPUTER-READABLE MEDIUM

(71) Applicant: Xiaomi Inc., Beijing (CN)

(72) Inventors: Dongxu Liu, Beijing (CN); Jiuping Yu, Beijing (CN); Nuo Yang, Beijing (CN)

(73) Assignee: Xiaomi Inc., Beijing (CN)

(21) Appl. No.: 15/374,209

(22) Filed: Dec. 9, 2016

(30) Foreign Application Priority Data
Dec. 11, 2015 (CN) 201510919429.5

(51) Int. Cl. G05B 13/02

(52) U.S. Cl. CPC G05B 13/0255

(57) ABSTRACT

The present disclosure relates to a method and device for controlling an intelligent device in the technological field of intelligent household appliances. The intelligent device is configured to acquire a current time and a current environment state, determine an operational running time for the intelligent device to adjust the current environment state to a first target environment state, wherein the first target environment state is an environment state to be achieved by a target time, and control the intelligent device based on the current time, the running time and the target time.

### CROSS-REFERENCE TO RELATED APPLICATION

This application claims priority to Chinese Patent Application No. 201510919429.5, filed on Dec. 11, 2015, the entirety of which is incorporated by reference herein.

### TECHNOLOGICAL FIELD

The present disclosure describes intelligent household appliances configured to sense environmental conditions, determine different settings and schedules for operation, and control operation to achieve different target environment conditions based on the sensed environmental conditions, settings, and schedules. The intelligent household appliances may reference historical information and/or current instructions to achieve the different target environmental conditions.

### BACKGROUND

With users paying more attention to the quality of life, intelligent devices that are able to achieve certain desired results with at least some level of autonomy have become found their way into homes. Users are often still required to provide manual control commands to an intelligent device to allow the intelligent device to fully operate. However, the process of controlling an intelligent device manually can be complicated and may inconvenience users. Therefore, a method for controlling an intelligent device having a simple process of controlling is contemplated.

### SUMMARY

An intelligent device, a method for controlling the intelligent device, and a computer-readable medium storing instructions for controlling operation of the intelligent device are provided in the present disclosure to overcome one or more problems existed in related arts.

According to a first embodiment of the present disclosure, a method for controlling an intelligent device is provided, the method comprising: acquiring a current time and a current environment state; determining a running time required to adjust the current environment state to a first target environment state, the first target environment state being an environment state at a target time, the target time being a time for controlling the intelligent device; and controlling the intelligent device based on the current time, the running time and the target time.

According to a second embodiment of the present disclosure, a device for controlling an intelligent device is provided, the device comprising: an acquiring module configured to acquire a current time and a current environment state; a first determining module configured to determine a running time required to adjust the current environment state to a first target environment state, the first target environment state being an environment state at a target time, the target time being a time for controlling the intelligent device; and a controlling module configured to control the intelligent device based on the current time, the running time and the target time. A module may include a combination of hardware, software, and/or circuitry for implementing its described features.

According to a third embodiment of the present disclosure, a device for controlling an intelligent device is provided, the device comprising: a processor; a memory for storing processor-executable instructions; wherein the processor is configured to: acquire a current time and a current environment state; determine a running time required to adjust the current environment state to a first target environment state, the first target environment state being an environment state at a target time, the target time being a time for controlling the intelligent device; and control the intelligent device based on the current time, the running time and the target time.

According to a fourth embodiment of the present disclosure, there is provided a non-transitory computer-readable storage medium having stored therein instructions that, when executed by a processor of a device, causes the device to perform a method for controlling an intelligent device, comprising: acquiring a current time and a current environment state; determining a running time required to adjust the current environment state to a first target environment state, the first target environment state being an environment state at a target time, the target time being a time for controlling the intelligent device; and controlling the intelligent device based on the current time, the running time and the target time.

It is to be understood that the forgoing general description and the following detailed description are illustrative and explanatory only, and are not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flow chart illustrating a method for controlling an intelligent device according to an exemplary embodiment of the present disclosure.

FIG. 2 is a flow chart illustrating another method for controlling an intelligent device according to an exemplary embodiment of the present disclosure.

FIG. 3 is a schematic diagram illustrating a function graph of a specified function according to an exemplary embodiment of the present disclosure.

FIG. 4 is a block diagram illustrating a first device for controlling an intelligent device according to an exemplary embodiment of the present disclosure.

FIG. 5 is a block diagram illustrating a controlling module according to an exemplary embodiment of the present disclosure.

FIG. 6 is a block diagram illustrating a controlling unit according to an exemplary embodiment of the present disclosure.

FIG. 7 is a block diagram illustrating a second device for controlling an intelligent device according to an exemplary embodiment of the present disclosure.

FIG. 8 is a block diagram illustrating a second determining module according to an exemplary embodiment of the present disclosure.

FIG. 9 is a block diagram illustrating a third device for controlling an intelligent device according to an exemplary embodiment of the present disclosure.

FIG. 10 is a block diagram illustrating a first updating module according to an exemplary embodiment of the present disclosure.

FIG. 11 is a block diagram illustrating a fourth device for controlling an intelligent device according to an exemplary embodiment of the present disclosure.

FIG. 12 is a block diagram illustrating a fourth determining module according to an exemplary embodiment of the present disclosure.

FIG. 13 is a block diagram illustrating a fifth device for controlling an intelligent device according to an exemplary embodiment of the present disclosure.

FIG. 14 is a block diagram illustrating a second updating module according to an exemplary embodiment of the present disclosure.

FIG. 15 is a block diagram illustrating a sixth device for controlling an intelligent device according to an exemplary embodiment of the present disclosure.

### DETAILED DESCRIPTION

Reference will now be made in detail to example embodiments, examples of which are illustrated in the accompanying drawings. The following description refers to the accompanying drawings in which same numbers in different drawings represent same or similar elements unless otherwise described. The implementations set forth in the following description of example embodiments do not represent all implementations consistent with the present disclosure. Instead, they are merely examples of device and methods consistent with aspects related to the present disclosure as recited in the appended claims.

In the embodiments of the present disclosure, an intelligent device may acquire a current time and a current environment state, and determine a running time required to adjust the current environment state to a first target environment state. Then the intelligent device may obtain a predicted time by adding the current time and the running time, and control the intelligent device automatically based on the predicted time and the target time. The control process is simple, and the operation overhead of user is decreased. In the embodiments of the present disclosure, the intelligent device may be controlled in advance before a target time to allow the intelligent device to operate, so as to ensure that the current environment state may be adjusted at a target time to a first target environment state needed by the user, increasing the user experience. For example, the intelligent device may determine the running time required to adjust the current environment state to the first target environment state through machine learning techniques or relying on past historical statistical data describing past user behaviors controlling the intelligent device to achieve the first target environment state.

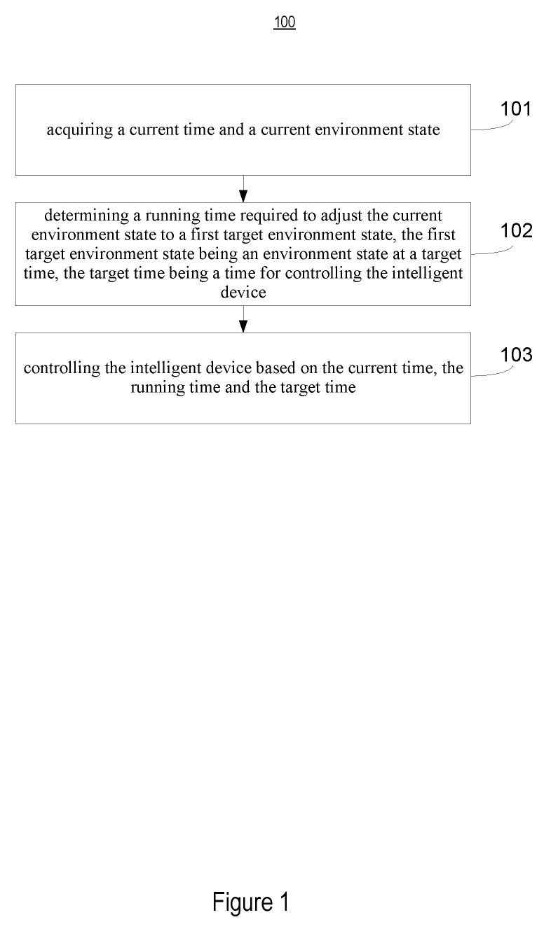

FIG. 1 is a flow chart 100 illustrating a method for controlling an intelligent device according to an exemplary embodiment of the present disclosure. For example, the method may be implemented by an intelligent device or another controller device configured to control the intelligent device. As shown in FIG. 1, the method may include the following steps.

In step 101, a current time and a current environment state may be acquired. The current time may be acquired from a clock application running on the controller device or the intelligent device. In addition or alternatively, the current time may be acquired from an off-site server running a clock timing application. The current environment state may be acquired from one or more sensors that are part of the controller device or the intelligent device. Exemplary sensors may include temperature sensors, moisture sensors, light sensors, pressure sensors, distance measuring sensors, or other known sensors for sensing an environmental state for an environment surrounding the intelligent device. The sensors may also be included in other devices in communication with the intelligent device so that the intelligent device may acquire sensor information from the other devices.

In step 102, a running time required to adjust the current environment state to a first target environment state may be determined, wherein the first target environment state may be an environment state at a target time, and the target time may be a time for initiating control of the intelligent device. After acquiring the current environment state, the intelligent device may calculate the running time required to adjust the current environment state to the first target environment state according to its own power. The running time may be an estimated time for the intelligent device to achieve the first target environment state.

It is to be noted that the first target environment state may be an environment state to which the intelligent device operates to achieve by adjusting the current environment state to become the first target environment state. The first target environment state may be determined based on operating habits of a user of the intelligent device. In addition, the target time may more specifically be a time for initiating control of the intelligent device to begin adjusting the environment state to achieve the first target environment state as determined, for example, based on the operating habits of a user.

In step 103, the intelligent device may be controlled to achieve the first target environment state based on the current time, the running time and the target time.

In the embodiments of the present disclosure, the intelligent device may acquire the current time and the current environment state, determine the running time required to adjust the current environment state to the first target environment state, and then control the intelligent device automatically based on the current time, the running time and the target time. The control process is simple, and the operation overhead for a user is decreased.

In some embodiments of the present disclosure, controlling the intelligent device based on the current time, the running time and the target time may comprise: obtaining a predicted time at which the intelligent device is predicted to achieve the first target environment state by adding the current time and the running time; and controlling the intelligent device based on the predicted time and the target time.

In some embodiments of the present disclosure, controlling the intelligent device to achieve the first target environment state based on the predicted time and the target time may comprise: controlling the intelligent device when the predicted time is determined to be the same as the target time; or determining a first difference value between the target time and the predicted time when the predicted time is determined not to be the same as the target time, and controlling the intelligent device when the first difference value is less than a first specified time.

In some embodiments of the present disclosure, before determining a running time required to adjust the current environment state to the first target environment state, the method may further comprise: selecting at least one valid environment state from a plurality of historical environment states, the historical environment states describing environment states previously adjusted successfully by the intelligent device before the current time; determining a first weighted value for the at least one valid environment state; and setting the first weighted value as the first target environment state.

In some embodiments of the present disclosure, determining the first weighted value for the at least one valid environment state may comprise: acquiring at least one first historical date corresponding to the at least one valid environment state, respectively, the at least one first historical date describing a date on which an environment state was adjusted to the valid environment state by the intelligent device; determining at least one first weight using a specified function based on the at least one first historical date; and calculating the first weighted value for the at least one valid environment state based on the at least one first weight.

In some embodiments of the present disclosure, the method may further comprise: receiving a first updating instruction, the first updating instruction carrying a second target environment state; and updating the plurality of historical environment states based on the second target environment state. The first updating instruction may be received, for example, from a user input. The first updating instruction may also be received, for example, from a data server that stores the user's historical control of environment states with respect to the intelligent device.

It is to be noted that the first updating instruction may be used to adjust the current environment state to the second target environment state. The first updating instruction may be triggered by a user. For example, the user may trigger the first updating instruction by implementing a specified operation such as inputting a clicking command via a button on the controller device, inputting a sliding command via a touch screen on the controller device, inputting a voice command via a microphone on the controller device and so on, and the embodiments of the present disclosure are not intended to limit in the context.

In some embodiments of the present disclosure, updating the plurality of historical environment states based on the second target environment state may comprise: acquiring at least one second historical date corresponding to the plurality of historical environment states, respectively, the at least one second historical date describing a date on which an environment state was previously adjusted successfully to the historical environment states by the intelligent device; selecting a historical environment state having an earliest second historical date from the plurality of historical environment states; and replacing the selected historical environment state with the second target environment state.

In some embodiments of the present disclosure, before determining the running time required to adjust the current environment state to the first target environment state, the method may further comprise: selecting at least one valid time from a plurality of historical times, the plurality of historical times describing times for controlling the intelligent device before the current time; determining a second weighted value for the at least one valid time; and determining the second weighted value as the target time.

In some embodiments of the present disclosure, determining the second weighted value for the at least one valid time may comprise: acquiring a third historical date for the at least one valid time respectively to obtain at least one third historical date, the third historical date being a date for controlling the intelligent device at the valid time; determining at least one second weight using a predetermined function based on the at least one third historical date; and calculating a second weighted value for the at least one valid time based on the at least one second weight.

In another embodiment of the present disclosure, the method may further comprise: upon receiving a second updating instruction, acquiring a receiving time for receiving the second updating instruction; and updating the plurality of the historical times based on the receiving time.

In some embodiments of the present disclosure, the updating the plurality of the historical times based on the receiving time may comprise: acquiring a fourth historical date for the plurality of historical times respectively, the fourth historical date being a date for controlling the intelligent device at the historical times; selecting a historical time having an earliest fourth historical date from the plurality of historical times; and replacing the selected historical time with the receiving time.

According to some embodiments, the above technical solutions may be combined in any manner to form optional embodiments of the present disclosure.

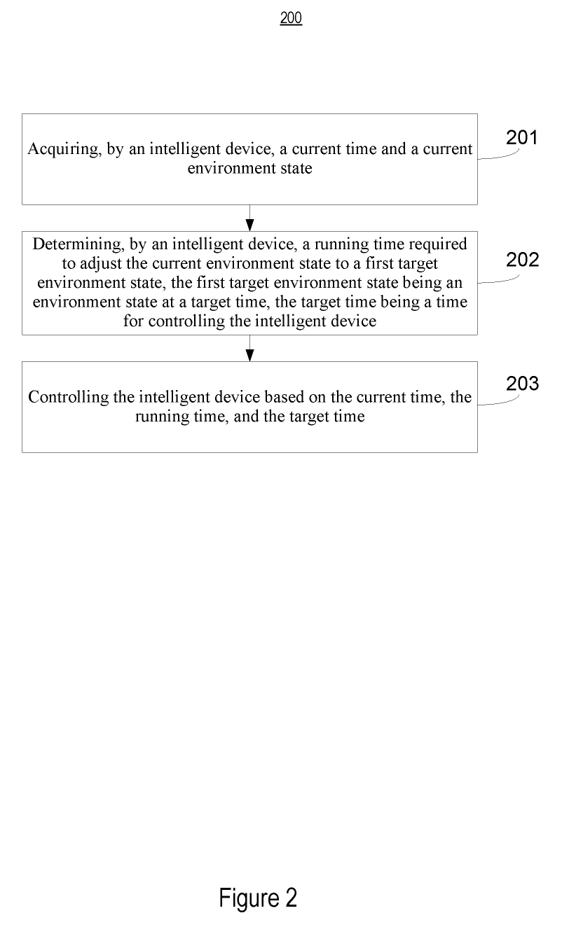

FIG. 2 is a flow chart 200 illustrating another method for controlling an intelligent device according to an exemplary embodiment of the present disclosure. For example, the method may be implemented by an intelligent device. As shown in FIG. 2, the method may include the following steps.

In step 201, the intelligent device may acquire a current time and a current environment state. The current time may be acquired from a clock application running on the intelligent device. In addition or alternatively, the current time may be acquired from an off-site server running a clock timing application. The current environment state may be acquired from one or more sensors that are part of the intelligent device. Exemplary sensors may include temperature sensors for sensing ambient temperature, moisture sensors for sensing ambient humidity, light sensors for sensing ambient light, pressure sensors for sensing ambient pressure, distance measuring sensors for sensing a distance to an object within a vicinity of the intelligent device, or other known sensors for sensing an environmental state for an environment surrounding the intelligent device.

Reference may further be made to related arts for the process of acquiring the current time and the current environment state by the intelligent device.

The type of sensors included on the intelligent device may be dependent on the type of appliance of the intelligent device. For example, the intelligent device may include a temperature sensor when the intelligent device is an intelligent air-conditioner, and the intelligent device may include a humidity sensor when the intelligent device is an intelligent humidifier.

In step 202, the intelligent device may determine a running time required to adjust the current environment state to a first target environment state, wherein the first target environment state may be an environment state at a target time, and the target time may be a time for initiating control of the intelligent device.

After acquiring the current environment state, the intelligent device may calculate the running time required to adjust the current environment state to the first target environment state according to its own power. The running time may be an estimated time for the intelligent device to achieve the first target environment state. Reference may be made to related arts for the calculation process, which will not be detailed herein.

It is to be noted that the first target environment state may be an environment state to which the intelligent device operates to achieve by adjusting the current environment state to become the first target environment state. The first target environment state may be determined based on operating habits of a user of the intelligent device. In addition, the target time may more specifically be a time for initiating control of the intelligent device to begin adjusting the environment state to achieve the first target environment state as determined, for example, based on the operating habits of a user.

Further, before determining the running time required to adjust the current environment state to the first target environment state, the intelligent device may determine the first target environment state and the target time based on the operating habits of the user. The operation of determining the first target environment state by the intelligent device may include the following step (a), and the operation of determining the target time by the intelligent device may include the following step (b).

At step (a), the intelligent device may select at least one valid environment state from a plurality of historical environment states, wherein the historical environment states may be stored in a look-up table or other database configured to store the historical environment states. The historical environment states may describe environment states previously achieved by the intelligent device (i.e., before the current time) by successfully adjusting the surrounding environment. The intelligent device may further determine a first weighted value for the at least one valid environment state, and set the first weighted value as the first target environment state.

When selecting at least one valid environment state from a plurality of historical environment states, the intelligent device may select from a specified range of environment states, and set the selected historical environment states from the specified range as the at least one valid environment state. Alternatively, the intelligent device may acquire one or more abnormal environment states from the plurality of historical environment states, and set environment states that were not selected as the abnormal environment states as the at least one valid environment states. Of course, the intelligent device may select at least one valid environment state from a plurality of historical environment states by other ways, which are not limited in the embodiments of the present disclosure. An abnormal state may describe a state that is not within the specified range (e.g., not within the range between the temperatures 14° C., 32° C., 16° C., and 33° C.).

For example, when the plurality of historical environment states includes 26° C. (Celsius, 24° C., 14° C., 27° C., 24° C., 28° C., 32° C., 24° C., 16° C., and 33° C., the specified range of environment states may be defined as temperatures ranging from 20° C.-30° C. With this specified range of environment states of temperatures ranging from 20° C.-30° C., the intelligent device may select one or more of the historical environment states that reside within 20° C.-30° C. (e.g., 26° C., 24° C., 27° C., 24° C., 28° C., and 24° C.). Then whichever historical environment states are selected (e.g., namely one or more of 26° C., 24° C., 27° C., 24° C., 28° C., and 24° C.), may be set to be the valid environment states.

Alternatively, when the plurality of historical environment states includes, for example, 26° C., 24° C., 14° C., 27° C., 24° C., 28° C., 32° C., 24° C., 16° C., and 33° C., the abnormal environment states selected from the plurality of historical environment states by the intelligent device may include 14° C., 32° C., 16° C., and 33° C. With this selection of abnormal environment states, the intelligent device may determine the historical environment states include 26° C., 24° C., 27° C., 24° C., 28° C., and 24° C., which coincides with the historical environment states that were not selected as the abnormal environment states (namely 14° C., 32° C., 16° C., and 33° C.). The historical environment states include 26° C., 24° C., 27° C., 24° C., 28° C., and 24° C., may then be set as the valid environment states.

It is to be noted that the valid environment states may be the environment states in the plurality of historical environment states that may be used to determine the first target environment state, and the abnormal environment states may be the environment states in the plurality of historical environment states that may be abnormal. In other words, the features of the abnormal environment states may differ from those of the historical environment states other than the abnormal environment states in the plurality of historical environment states.

In addition, the specified range of environment states may be preset. For example, the specified range describing temperatures ranging from 20° C.-30° C., may have been a preset range.

When acquiring the abnormal environment states from the plurality of historical environment states, the intelligent device may acquire the abnormal environment states by its own anomaly detection module, or may acquire the abnormal environment states by an installed third-party anomaly detection application. The embodiments of the present disclosure are not intended to limit in the context.

It is to be noted that the third-party anomaly detection application may be used to detect the abnormal data from a plurality of data that may include abnormal data as well as other data, the features of which differ from those of the data other than the abnormal data in the plurality of data. For example, the third-party anomaly detection application may be an SPSS (Statistical Product and Service Solutions) application, an SAS (Statistical Analysis System) application or the like, and the embodiments of the present disclosure are not intended to limit in the context.

When determining a first weighted value for the at least one valid environment state, the intelligent device may acquire at least one first historical date corresponding to the at least one valid environment state, respectively, wherein each first historical date acquired by the intelligent device may be a date on which an environment state was adjusted to a valid environment state by the intelligent device. The intelligent device may further determine at least one first weight using a specified function based on the at least one first historical date, and calculate a first weighted value for the at least one valid environment state based on the at least one first weight.

It is to be noted that the first historical date for the at least one valid environment state may be a date on which the at least one valid environment state was stored by the intelligent device, respectively.

In addition, the specified function may be a predetermined function. For example, the specified function may be an inverse proportional function such as

$$y = \frac{k}{x} ( k > 0 , x > 0 )$$

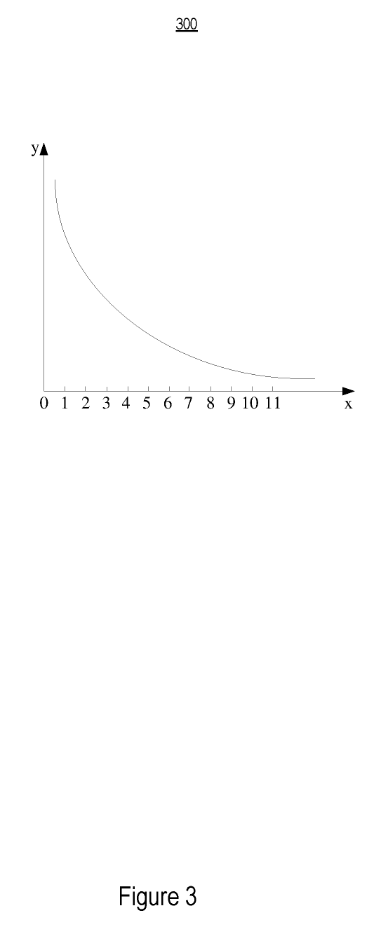

or another function having a relationship as depicted by graph 300 in FIG. 3, which is not limited in the embodiments of the present disclosure.

The first weight may be a representation of the level to which the valid environment state corresponding to the first weight can be relied upon in determining a first target environment state.

When determining the at least one first weight using the specified function based on the at least one first historical date, the intelligent device may acquire the current date, and calculate a second difference value between the current date and the at least one first historical date respectively to obtain at least one second difference value, and then determine the at least one first weight using the specified function based on the at least one second difference value.

For example, consider when the at least one first historical date includes Dec. 5, 2014, Dec. 6, 2014, Dec. 9, 2014, Dec. 10, 2014, Dec. 11, 2014, and Dec. 15, 2014 and when the current date is Dec. 18, 2014. Then the second difference value between the current date and the at least one first historical date may be calculated respectively to obtain the at least one second difference values as 13, 12, 9, 8, 7, and 3 days. The at least one first weight may then be determined using the specified function based on the at least one second difference value of 13, 12, 9, 8, 7, and 3 days.

When determining the at least one first weight using the specified function based on the at least one second difference value, the intelligent device may take the least one second difference value as an independent variable for the specified function to calculate a dependent variable corresponding to the at least one second difference value respectively to obtain at least one dependent variable, and determine the at least one dependent variable as the at least one first weight.

For example, the specified function may be

$$y = \frac{1}{x} ( x > 0 ) ,$$

and the at least one second difference value may include 13, 12, 9, 8, 7, and 3 days. By substituting 13, 12, 9, 8, 7, and 3 days into

$$y = \frac{1}{x} ( x > 0 ) ,$$

the dependent variables corresponding to 13, 12, 9, 8, 7, and 3 are 1/13, 1/12, 1/9, ⅛, 1/7, and ⅓, respectively. Therefore, the at least one first weight may be one of 1/13, 1/12, 1/9, ⅛, 1/7, and ⅓.

When calculating a first weighted value for the at least one valid environment state based on the at least one first weight, the intelligent device may multiply the at least one valid environment state by the corresponding first weight to obtain at least one first value, and then add the at least one first value to obtain a first weighted value.

For example, the at least one valid environment state may include 26° C., 24° C., 27° C., 24° C., 28° C., and 24° C., such that the first weight corresponding to 26° C. may be 1/13, the first weight corresponding to 24° C. may be 1/12, the first weight corresponding to 27° C. may be 1/9, the first weight corresponding to 24° C. may be ⅛, the first weight corresponding to 28° C. may be 1/7, and the first weight corresponding to 24° C. may be ⅓, respectively. Then the first weighted value may be 26× 1/13+24× 1/12+27× 1/9+24×⅛+28× 1/7+24×⅓=22, respectively.

The intelligent device may determine the first target environment state based on the operating habits of a user, which may vary gradually due to the influence of factors such as the different seasons throughout the year and may be reflected by the plurality of historical environment states in the different embodiments of the present disclosure. It follows that the plurality of historical environment states may be updated accordingly. In other words, the intelligent device may receive a first updating instruction carrying a second target environment state, and may update the plurality of historical environment states based on the second target environment state, so that the plurality of historical environment states may reflect the latest operating habits of the user, thus providing the accuracy of the first target environment state determined based on the plurality of historical environment states. The closer the historical environment state gets the more the weight value. The target environment states may be calculated based on the historical environment states, which are the states that has been used by the user.

It is to be noted that the first updating instruction may be used to adjust the current environment state to the second target environment state by the intelligent device. The first updating instruction may be triggered by a user. For example, the user may trigger the first updating instruction by implementing a specified operation such as inputting a clicking command via a button on the intelligent device, inputting a sliding command via a touch screen on the intelligent device, inputting a voice command via a microphone on the intelligent device and so on, and the embodiments of the present disclosure are not intended to limit in the context.

When updating the plurality of historical environment states based on the second target environment state, the intelligent device may acquire a second historical date for the plurality of historical environment states, respectively, wherein the second historical date may be a date on which an environment state was adjusted to the historical environment states by the intelligent device. The intelligent device may further select a historical environment state having an earliest second historical date from the plurality of historical environment states, and replace the selected historical environment state with the second target environment state. Alternatively, the intelligent device may acquire at least one abnormal environment state from the plurality of historical environment states, and replace any of the at least one abnormal environment state with the second target environment state. Of course, the intelligent device may update the plurality of historical environment states based on the second target environment state by other ways, and the embodiments of the present disclosure are not intended to limit in the context.

It is to be noted that the second historical date may be a date on which the plurality of historical environment states were stored by the intelligent device, respectively.

For example, the second target environment state may be 28° C., and the plurality of historical environment states may include 26° C., 24° C., 14° C., 27° C., 24° C., 28° C., 32° C., 24° C., 16° C., and 33° C. The second historical date corresponding to the plurality of historical environment states (26° C., 24° C., 14° C., 27° C., 24° C., 28° C., 32° C., 24° C., 16° C., 33° C.) may be Dec. 5, 2014, Dec. 6, 2014, Dec. 8, 2014, Dec. 9, 2014, Dec. 10, 2014, Dec. 11, 2014, Dec. 12, 2014, Dec. 15, 2014, Dec. 16, 2014, and Dec. 17, 2014, respectively. Here, the historical environment state having an earliest second historical date is 26° C. on Dec. 5, 2014, in which case the intelligent device may replace the historical environment state with the earliest second historical date (26° C.) with the second target environment state (28° C.). This

As another example, the second target environment state may be 28° C., and the plurality of historical environment states may be 26° C., 24° C., 14° C., 27° C., 24° C., 28° C., 32° C., 24° C., 16° C., and 33° C. The at least one abnormal environment state acquired from the plurality of historical environment states by the intelligent device may be 14° C., 32° C., 16° C., and 33° C., in which case the intelligent device may replace any of the abnormal environment states (14° C., 32° C., 16° C., and 33° C.) with the second target environment state (28° C.).

At step (b) the intelligent device may select at least one valid time from a plurality of historical times, wherein the historical times may describe previous times when the intelligent device was controlled to achieve a target environment state, determine a second weighted value for the at least one valid time, and set the second weighted value as the target time.

When selecting the at least one valid time from the plurality of historical times, the intelligent device may select from historical times within a specified time range, and determine the selected historical times as the at least one valid time. Alternatively, the intelligent device may acquire abnormal times from the plurality of historical times, and determine the historical times that were not selected as abnormal times to be the at least one valid time. The intelligent device may also select the at least one valid time from a plurality of historical times by other ways, and the embodiments of the present disclosure are not intended to limit in the context.

For example, the plurality of historical times may include 18:26, 18:24, 13:14, 18:27, 18:24, 18:28, 15:32, 18:24, 23:16, and 17:33 (according to the 24 hour clock), and the specified time range may be a range from 18:00-22:00 (according to the 24 hour clock). Then the intelligent device may select the historical times 18:26, 18:24, 18:27, 18:24, 18:28, and 18:24, time that are within the range of 18:00-22:00, from the plurality of historical times. It follows that the selected historical times, namely 18:26, 18:24, 18:27, 18:24, 18:28, and 18:24, may be set to be the at least one valid times.

As another example, the plurality of historical times may include 18:26, 18:24, 13:14, 18:27, 18:24, 18:28, 15:32, 18:24, 23:16, and 17:33 (according to the 24 hour clock), and the abnormal times acquired from the plurality of historical times by the intelligent device may include 13:14, 15:32, 23:16, and 17:33 (according to the 24 hour clock). Then the intelligent device may determine that the historical times that are not identified as abnormal times include 18:26, 18:24, 18:27, 18:24, 18:28, and 18:24, which may then be set as the at least one valid times.

It is to be noted that the valid times may be the times in the plurality of historical times that may be used to determine the target time, and the abnormal times may be the times in the plurality of historical times that may be abnormal. In other words, the features of the abnormal times may differ from those of the historical times other than the abnormal times in the plurality of historical times.

In addition, the specified time range may be preset. For example, the range of 18:00-22:00 may be a preset range.

When acquiring the abnormal times from the plurality of historical times, the intelligent device may acquire the abnormal times by its own anomaly detection module, and may also acquire the abnormal times by an installed third-party anomaly detection application, and the embodiments of the present disclosure are not intended to limit in the context.

When determining the second weighted value for the at least one valid time, the intelligent device may acquire at least one third historical date corresponding to the at least one valid time, respectively, wherein the third historical date may be a date for controlling the intelligent device at the valid time. The intelligent device may further determine at least one second weight using a specified function based on the at least one third historical date, and calculate a second weighted value for the at least one valid time based on the at least one second weight.

It is to be noted that the third historical date of the at least one valid time may be a date on which the at least one valid time was stored by the intelligent device, respectively.

In addition, the second weight may be a representation of the level to which the valid time corresponding to the second weight can be relied upon when determining the target time.

The process of determining at least one second weight using a specified function based on the at least one third historical date by the intelligent device may be similar to the process of determining at least one first weight in step (a) of step 202, which will not be detailed herein.

When calculating the second weighted value for the at least one valid time based on the at least one second weight, the intelligent device may multiply the at least one valid time by the corresponding second weight to obtain at least one second value, and then add the at least one second value together to obtain a second weighted value.

For example, the at least one valid time may be 18:26, 18:24, 18:27, 18:24, 18:28, and 18:24 (according to the 24 hour clock), and the second weight corresponding to 18:26 may be 1/13, the second weight corresponding to 18:24 may be 1/12, the second weight corresponding to 18:27 may be 1/9, the second weight corresponding to 18:24 may be ⅛, the second weight corresponding to 18:28 may be 1/7, and the second weight corresponding to 18:24 may be ⅓. In this case, the second weighted value may be 18:26× 1/13+18:24× 1/12+18:27× 1/9+18:24×⅛+18:28× 1/7+18:24×⅓=18:22.

The intelligent device may determine the target time based on the operating habits of a user, which may vary gradually due to the influence of some factors such as the different seasons throughout the year and may be reflected by the plurality of historical times in the different embodiments of the present disclosure. It follows that the plurality of historical times may be updated accordingly. In other words, the intelligent device may acquire a receiving time for receiving a second updating instruction upon receiving the second updating instruction, and update the plurality of the historical times based on the receiving time, so that the plurality of historical times may reflect the latest operating habits of a user, thus providing the accuracy of a target time determined based on the plurality of historical times.

It is to be noted that the second updating instruction may be used to control the intelligent device. The second updating instruction may be triggered by a user. For example, the user may trigger the second updating instruction by implementing a specified operation such as inputting a clicking command via a button on the intelligent device, inputting a sliding command via a touch screen on the intelligent device, inputting a voice command via a microphone on the intelligent device and so on, and the embodiments of the present disclosure are not intended to limit in the context.

When updating the plurality of the historical times based on the receiving time, the intelligent device may acquire a fourth historical date of the plurality of historical times, respectively, wherein the fourth historical date may be a date for controlling the intelligent device at the historical times. The intelligent device may further select a historical time having an earliest fourth historical date from the plurality of historical times; and replace the selected historical time with the receiving time. Alternatively, the intelligent device may acquire at least one abnormal time from the plurality of historical times, and replace any of the at least one abnormal time with the receiving time. Of course, the intelligent device may update the plurality of historical times based on the receiving time by other ways, and the embodiments of the present disclosure are not intended to limit in the context.

It is to be noted that the fourth historical date may be a date on which the plurality of historical times were stored by the intelligent device respectively.

For example, the receiving time may be 18:39, and the plurality of historical times may include 18:26, 18:24, 13:14, 18:27, 18:24, 18:28, 15:32, 18:24, 23:16, and 17:33 (according to the 24 hour clock). The fourth historical date corresponding to the plurality of historical times (18:26, 18:24, 13:14, 18:27, 18:24, 18:28, 15:32, 18:24, 23:16, and 17:33) may be Dec. 5, 2014, Dec. 6, 2014, Dec. 8, 2014, Dec. 9, 2014, Dec. 10, 2014, Dec. 11, 2014, Dec. 12, 2014, Dec. 15, 2014, Dec. 16, 2014, and Dec. 17, 2014, respectively. Here, the historical time having the earliest fourth historical date is 18:26 on Dec. 5, 2014, in which case the intelligent device may replace the historical time with the earliest fourth historical date (18:26) with the receiving time (18:39).

As another example, the receiving time may be 18:39, and the plurality of historical times may include 18:26, 18:24, 13:14, 18:27, 18:24, 18:28, 15:32, 18:24, 23:16, and 17:33 (according to the 24 hour clock), and the at least one abnormal time acquired from the plurality of historical times by the intelligent device may include 13:14, 15:32, 23:16, and 17:33. In this case, then, the intelligent device may replace any of the abnormal times (13:14, 15:32, 23:16, and 17:33) with the received time (18:39).

In step 203, the intelligent device may be controlled based on the current time, the running time and the target time.

The intelligent device may predict that a user will adjust the current environment state to the first target environment state at the target time. In other words, the intelligent device may predict the environment state at the target time to be the first target environment state. Therefore, in order to ensure the environment state at the target time to be the first target environment state, the intelligent device may generate a predicted time by adding the running time to the current time, and then control the intelligent device based on the predicted time and the target time.

In obtaining the predicted time, the intelligent device may obtain the predicted time in real time, or may obtain the predicted time at an interval of a second specified time. The intelligent device may not obtain the predicted time when the intelligent device obtains the predicted time within a time period far from the target time, since the predicted time is far from the target time and the intelligent device will not be controlled to adjust the current environment state to the first target environment state. Therefore, the intelligent device may determine a target time period based on the target time included in the target time period, and obtain the predicted time in real time within the target time period or obtain the predicted time at an interval of the second specified time within the target time period, so as to avoid obtaining the predicted time blindly within a time period far from the target time, saving on the processing resources of the intelligent device.

In order to obtain the predicted time in real time, the intelligent device may acquire the current time and the current environment state in real time. In order to obtain the predicted time at the interval of the second specified time, the intelligent device may acquire the current time and the current environment state at the interval of the second specified time.

It is to be noted that the second specified time may be preset. For example, the second specified time may be preset to be 5 minutes, 6 minutes and so on. The embodiments of the present disclosure are not intended to limit in the context.

When controlling the intelligent device based on the predicted time and the target time, the intelligent device may obtain the predicted time in real time, and control the intelligent device when the predicted time is the same as the target time, thereby increasing the accuracy of controlling the intelligent device. Alternatively, the intelligent device may obtain the predicted time at the interval of the second specified time, and in this case, the intelligent device may determine a first difference value between the target time and the predicted time, and control the intelligent device when the first difference value is less than a first specified time, thereby saving the processing resources of the intelligent device.

It is to be noted that the first specified time may be preset. For example, the first specified time may be preset to be 1 minute, 5 minutes and so on, and the embodiments of the present disclosure are not intended to limit in the context.

For example, when a predicted time is 18:22, and a target time is 18:22, then the intelligent device may be controlled since the predicted time is the same as the target time.

As another example, the first specified time may be 5 minutes, the predicted time may be 18:19, and the target time may be 18:22. The first difference value between the target time and the predicted time in this case is 3 minutes. Therefore the determination for controlling the intelligent device may be confirmed based on the first difference value (i.e. 3 minutes) being less than the first specified time (i.e. 5 minutes).

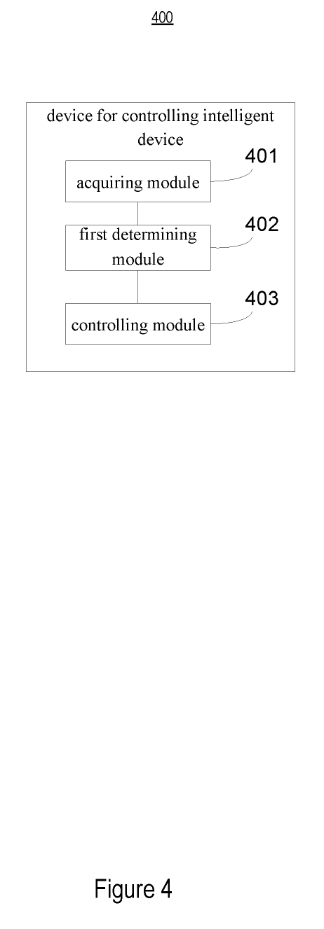

FIG. 4 is a block diagram illustrating a device 400 for controlling an intelligent device according to an example embodiment of the present disclosure. Referring to FIG. 4, the device may comprise: an acquiring module 401 configured to acquire a current time and a current environment state; a first determining module 402 configured to determine a running time required to adjust the current environment state to a first target environment state, the first target environment state being an environment state at a target time, the target time being a time for controlling the intelligent device; and a controlling module 403 configured to control the intelligent device based on the current time, the running time and the target time.

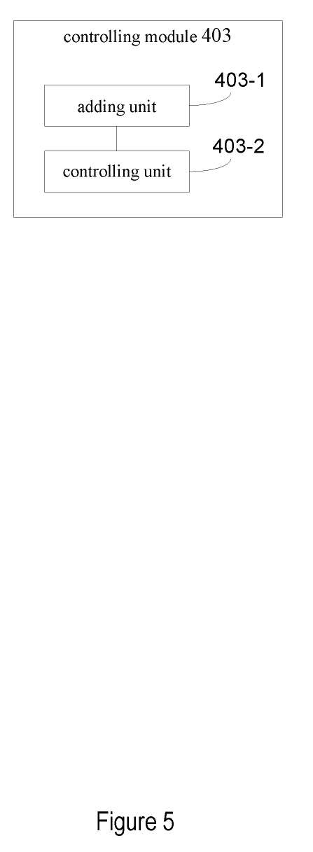

Referring to FIG. 5, according to some embodiments of the present disclosure, the controlling module 403 may comprise: an adding unit 403-1 configured to obtain a predicted time by adding the current time and the running time; and a controlling unit 403-2 configured to control the intelligent device based on the predicted time and the target time.

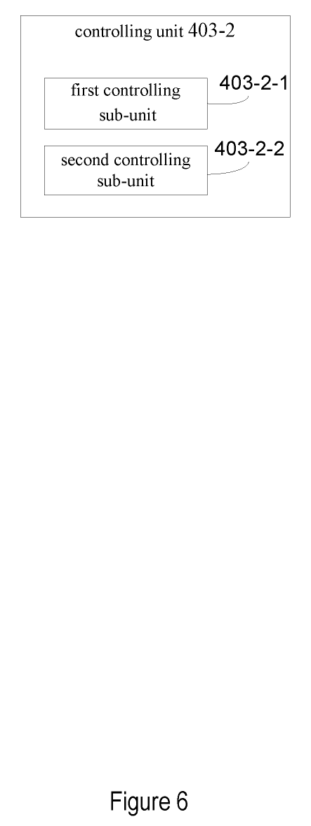

Referring to FIG. 6, according to some embodiments of the present disclosure, the controlling unit 403-2 may comprise: a first controlling sub-unit 403-2-1 configured to control the intelligent device when the predicted time is the same as the target time; or a second controlling sub-unit 403-2-2 configured to determine a first difference value between the target time and the predicted time, and control the intelligent device when the first difference value is less than a first specified time.

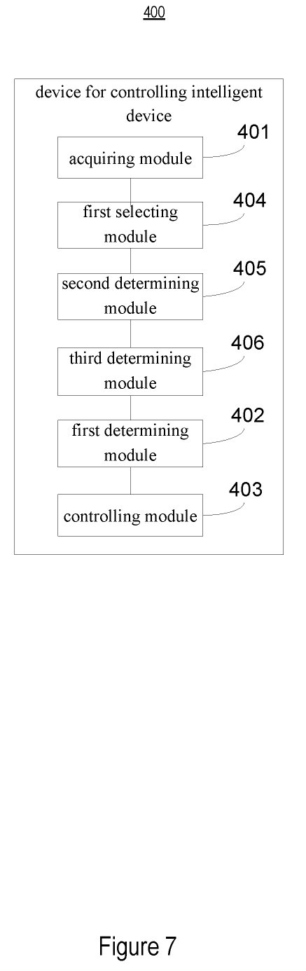

Referring to FIG. 7, according to some embodiments of the present disclosure, the device 400 may further comprise: a first selecting module 404 configured to select at least one valid environment state from a plurality of historical environment states, the historical environment states being environment states adjusted by the intelligent device before the current time; a second determining module 405 configured to determine a first weighted value for the at least one valid environment state; and a third determining module 406 configured to determine the first weighted value as the first target environment state.

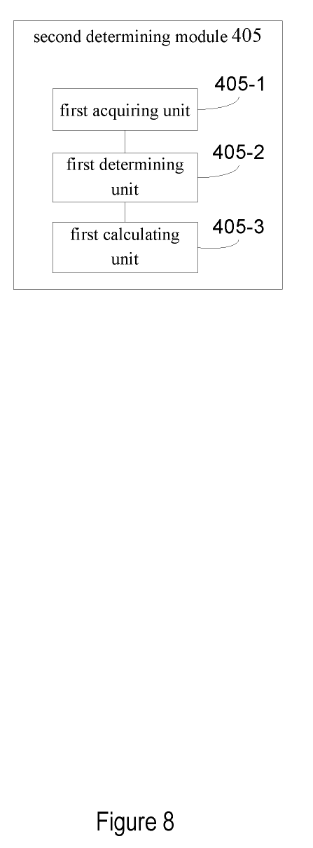

Referring to FIG. 8, according to some embodiments of the present disclosure, the second determining module 405 may comprise: a first acquiring unit 405-1 configured to acquire a first historical date of for the at least one valid environment state respectively to obtain at least one first historical date, the first historical date being a date on which an environment state was adjusted to the valid environment state by the intelligent device; a first determining unit 405-2 configured to determine at least one first weight using a specified function based on the at least one first historical date; and a first calculating unit 405-3 configured to calculate a first weighted value for the at least one valid environment state based on the at least one first weight.

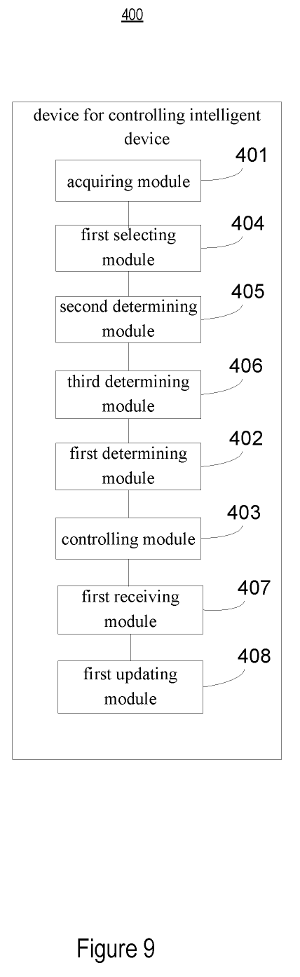

Referring to FIG. 9, according to some embodiments of the present disclosure, the device 400 may further comprise: a first receiving module 407 configured to receive a first updating instruction, the first updating instruction carrying a second target environment state; and a first updating module 408 configured to update the plurality of historical environment states based on the second target environment state.

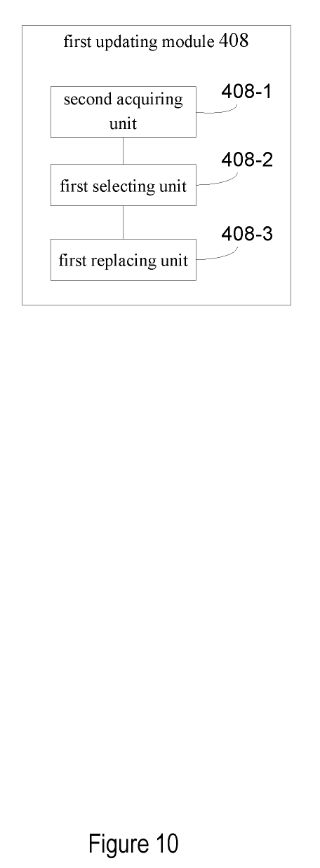

Referring to FIG. 10, according to some embodiments of the present disclosure, the first updating module 408 may comprise: a second acquiring unit 408-1 configured to acquire a second historical date of for the plurality of historical environment states respectively, the second historical date being a date on which an environment state was adjusted to the historical environment states by the intelligent device; a first selecting unit 408-2 configured to select from the plurality of historical environment states a historical environment state having an earliest second historical date; and a first replacing unit 408-3 configured to replace the selected historical environment state with the second target environment state.

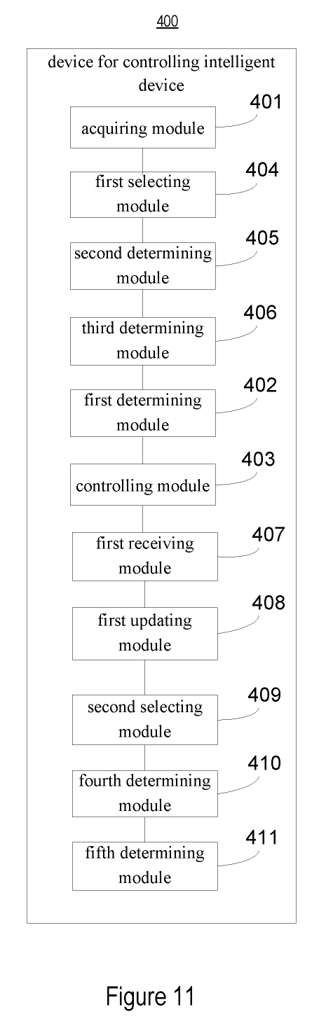

Referring to FIG. 11, according to some embodiments of the present disclosure, the device 400 may further comprise: a second selecting module 409 configured to select at least one valid time from a plurality of historical times, the historical times being times for controlling the intelligent device before the current time; a fourth determining module 410 configured to determine a second weighted value for the at least one valid time; and a fifth determining module 411 configured to determine the second weighted value as the target time.

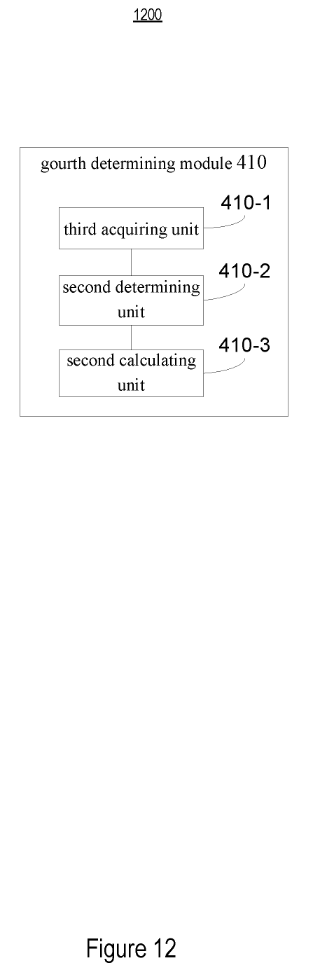

Referring to FIG. 12, according to some embodiments of the present disclosure, the fourth determining module 410 may comprise: a third acquiring unit 410-1 configured to acquire a third historical date for the at least one valid time respectively to obtain at least one third historical date, the third historical date being a date for controlling the intelligent device at the valid time; a second determining unit 410-2 configured to determine at least one second weight using a specified function based on the at least one third historical date; and a second calculating unit 410-3 configured to calculate a second weighted value for the at least one valid time based on the at least one second weight.

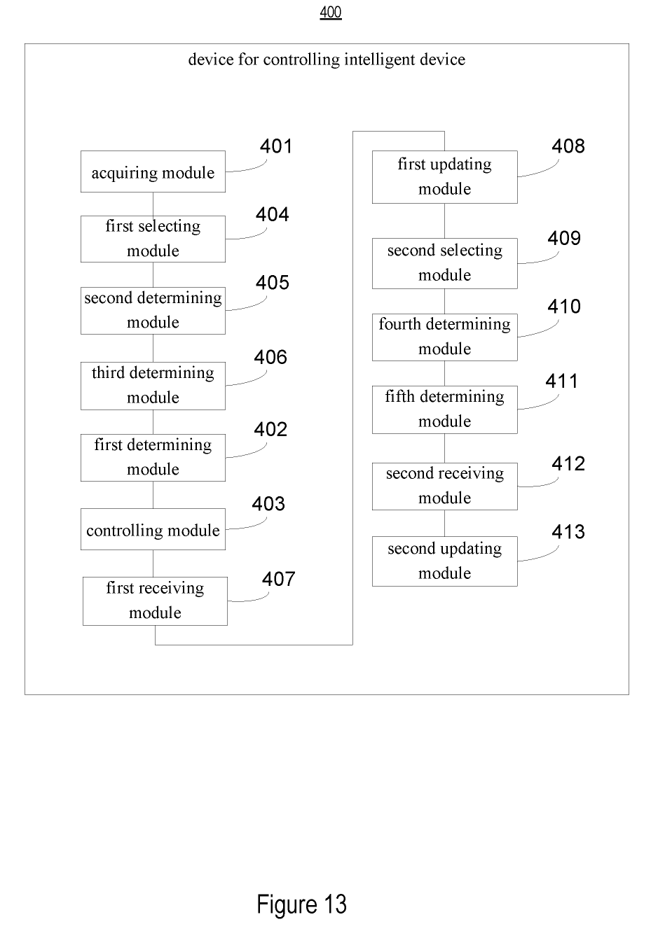

Referring to FIG. 13, according to some embodiments of the present disclosure, the device 400 may further comprise: a second receiving module 412 configured to acquire, upon receiving the second updating instruction, a receiving time for receiving a second updating instruction; and a second updating module 413 configured to update the plurality of the historical times based on the receiving time.

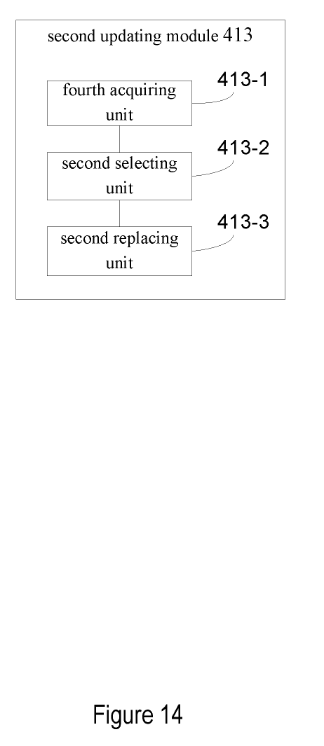

Referring to FIG. 14, according to some embodiments of the present disclosure, the second updating module 413 may comprise: a fourth acquiring unit 413-1 configured to acquire a fourth historical date for the plurality of historical times respectively, the fourth historical date being a date for controlling the intelligent device at the historical times; a second selecting unit 413-2 configured to select from the plurality of historical times a historical time having an earliest fourth historical date; and a second replacing unit 413-3 configured to replace the selected historical time with the receiving time.

In the embodiments of the present disclosure, the intelligent device may acquire the current time and the current environment state, determine the running time required to adjust the current environment state to the first target environment state, and then control the intelligent device automatically based on the current time, the running time and the target time. The control process is simple, and the operation overhead for a user is decreased.

With respect to the devices in above embodiments, specific manners in which respective modules perform operations have been described in detail in embodiments related to methods, which will not be elaborated herein.

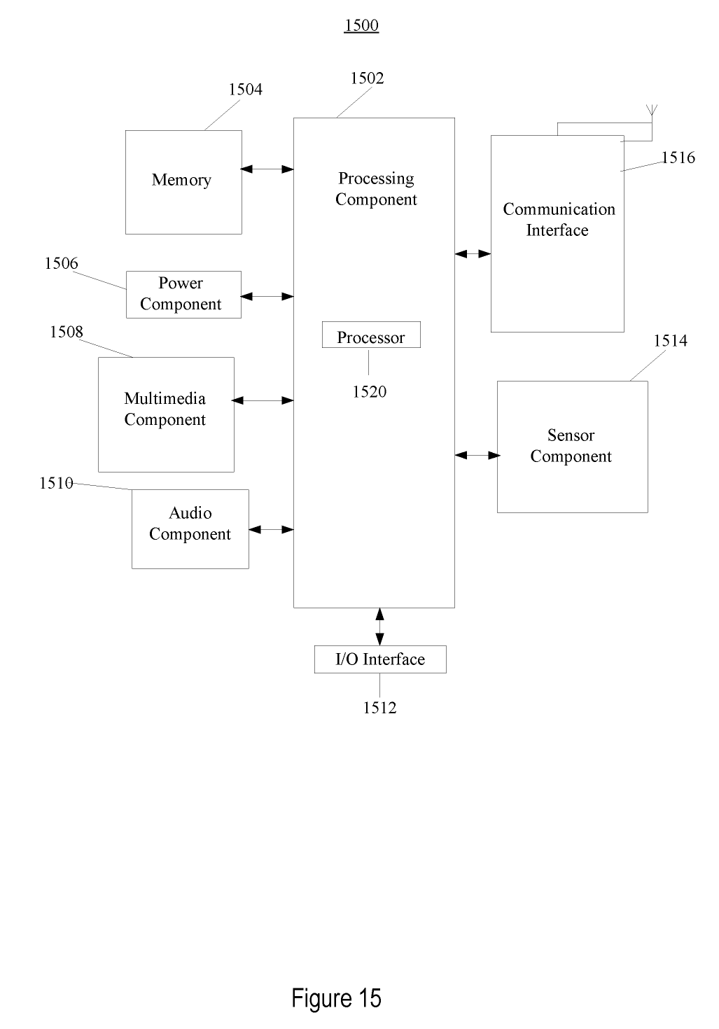

FIG. 15 is a block diagram illustrating an exemplary computing device 1500 for controlling an intelligent device according to the present disclosure. For example, the computing device 1500 may be a standalone controller device in communication with the intelligent device. Alternatively, the computing device 1500 may be included as part of the intelligent device.

Referring to FIG. 15, the computing device 1500 may include one or more of the following components: a processing component 1502, a memory 1504, a power component 1506, a multimedia component 1508, an audio component 1510, an input/output (I/O) interface 1512, a sensor component 1514, and a communication interface 1516.

The processing component 1502 controls overall operations of the computing device 1500, such as the operations associated with display, data communications, and recording operations, as well as for implementing the processes described herein. The processing component 1502 may include one or more processors 1520 to execute instructions to perform all or part of the steps in the above described methods. Moreover, the processing component 1502 may include one or more modules which facilitate the interaction between the processing component 1502 and other components. For instance, the processing component 1502 may include a multimedia module to facilitate the interaction between the multimedia component 1508 and the processing component 1502. A module may include a combination of hardware, software, and/or circuitry for implementing its described features.

The memory 1504 is configured to store various types of data to support the operation of the computing device 1500. Examples of such data include instructions for any applications or methods operated on the computing device 1500, environmental states, times, and other information referenced by the processing component 1502. For example, the memory 1504 may include the database for storing the historical environment states. The memory 1504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1506 provides power to various components of the computing device 1500. The power component 1506 may include a power management system, one or more power sources, and any other components associated with the generation, management, and distribution of power in the computing device 1500.

The multimedia component 1508 includes a screen providing an output interface between the computing device 1500 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action.

The audio component 1510 is configured to output and/or input audio signals. For example, the audio component 1510 includes a microphone (“MIC”) configured to receive an external audio signal when the computing device 1500 is in an operation mode, such as a recording mode and a voice recognition mode. The received audio signal may be further stored in the memory 1504 or transmitted via the communication interface 1516. In some embodiments, the audio component 1510 further includes a speaker to output audio signals.

The I/O interface 1512 provides an interface between the processing component 1502 and peripheral interface modules, such as a keyboard, a click wheel, buttons, and the like. The buttons may include, but are not limited to, a home button, a volume button, a starting button, and a locking button.

The sensor component 1514 includes one or more sensors to provide status assessments of various aspects of the computing device 1500. For instance, the sensor component 1514 may detect an open/closed status of the computing device 1500, relative positioning of components, e.g., the display and the keypad, of the computing device 1500, a change in position of the computing device 1500 or a component of the computing device 1500, a presence or absence of user contact with the computing device 1500, an orientation or an acceleration/deceleration of the computing device 1500, and a change in temperature of the computing device 1500. The sensor component 1514 may include a proximity sensor configured to detect the presence of nearby objects without any physical contact. The sensor component 1514 may also include a light sensor, such as a CMOS or CCD image sensor, for use in imaging applications. In some embodiments, the sensor component 1514 may also include an accelerometer sensor, a gyroscope sensor, a magnetic sensor, a pressure sensor, or a temperature sensor.

The communication interface 1516 is configured to facilitate communication, wired or wirelessly, between the computing device 1500 and other devices. The computing device 1500 can access a wireless network based on a communication standard, such as WiFi, 2G, or 3G, or a combination thereof. In one example embodiment, the communication interface 1516 receives a broadcast signal or broadcast associated information from an external broadcast management system via a broadcast channel. In one example embodiment, the communication interface 1516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the computing device 1500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In example embodiments, there is also provided a non-transitory computer readable storage medium including instructions, such as included in the memory 1504, executable by the processor 1520 in the computing device 1500, for performing the above-described methods. For example, the non-transitory computer-readable storage medium may be a ROM, a random access memory (RAM), a CD-ROM, a magnetic tape, a floppy disc, an optical data storage device, and the like.

A non-transitory computer readable storage medium having stored therein instructions that, when executed by the processor of the computing device 1500, causes the computing device 1500 to perform the above described methods for controlling an intelligent device. The methods comprising, for example: acquiring a current time and a current environment state; determining a running time required to adjust the current environment state to a first target environment state, the first target environment state being an environment state at a target time, the target time being a time for controlling the intelligent device; and controlling the intelligent device based on the current time, the running time and the target time.

According to some embodiments of the present disclosure, controlling the intelligent device based on the current time, the running time and the target time may comprise: obtaining a predicted time by adding the current time and the running time; and controlling the intelligent device based on the predicted time and the target time.

According to some embodiments of the present disclosure, controlling the intelligent device based on the predicted time and the target time may comprise: controlling the intelligent device when the predicted time is the same as the target time; or determining a first difference value between the target time and the predicted time, and controlling the intelligent device when the first difference value is less than a first specified time.

According to some embodiments of the present disclosure, the method may further comprise, before the determining a running time required to adjust the current environment state to a first target environment state: selecting at least one valid environment state from a plurality of historical environment states, the historical environment states being environment states adjusted by the intelligent device before the current time; determining a first weighted value for the at least one valid environment state; and determining the first weighted value as the first target environment state.

According to some embodiments of the present disclosure, determining a first weighted value for the at least one valid environment state may comprise: acquiring a first historical date for the at least one valid environment state respectively to obtain at least one first historical date, the first historical date being a date on which an environment state was adjusted to the valid environment state by the intelligent device; determining at least one first weight using a specified function based on the at least one first historical date; and calculating a first weighted value for the at least one valid environment state based on the at least one first weight.

According to some embodiments of the present disclosure, the method may further comprise: receiving a first updating instruction, the first updating instruction carrying a second target environment state; and updating the plurality of historical environment states based on the second target environment state.

According to some embodiments of the present disclosure, updating the plurality of historical environment states based on the second target environment state may comprise: acquiring a second historical date for the plurality of historical environment states respectively, the second historical date being a date on which an environment state was adjusted to the historical environment states by the intelligent device; selecting from the plurality of historical environment states a historical environment state having an earliest second historical date; and replacing the selected historical environment state with the second target environment state.

According to some embodiments of the present disclosure, the method may further comprise, before the determining a running time required to adjust the current environment state to a first target environment state: selecting at least one valid time from a plurality of historical times, the historical times being times for controlling the intelligent device before the current time; determining a second weighted value for the at least one valid time; and determining the second weighted value as the target time.

According to some embodiments of the present disclosure, determining a second weighted value for the at least one valid time may comprise: acquiring a third historical date for the at least one valid time respectively to obtain at least one third historical date, the third historical date being a date for controlling the intelligent device at the valid time; determining at least one second weight using a specified function based on the at least one third historical date; and calculating a second weighted value for the at least one valid time based on the at least one second weight.

According to some embodiments of the present disclosure, the method may further comprise: acquiring, upon receiving a second updating instruction, a receiving time for receiving the second updating instruction; and updating the plurality of the historical times based on the receiving time.

According to some embodiments of the present disclosure, updating the plurality of the historical times based on the receiving time may comprise: acquiring a fourth historical date for the plurality of historical times respectively, the fourth historical date being a date for controlling the intelligent device at the historical times; selecting from the plurality of historical times a historical time having an earliest fourth historical date; and replacing the selected historical time with the receiving time.

According to some embodiments of the present disclosure, the intelligent device may acquire the current time and the current environment state, determine the running time required to adjust the current environment state to the first target environment state, and then control the intelligent device automatically based on the current time, the running time and the target time. The control process is simple, and the operation overhead for a user is decreased.

Other embodiments of the invention will be apparent to those skilled in the art from consideration of the specification and practice of the disclosures herein. This application is intended to cover any variations, uses, or adaptations of the disclosure following the general principles thereof and including such departures from the present disclosure as come within known or customary practice in the art. It is intended that the specification and embodiments be considered as illustrative only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for controlling an intelligent device, comprising:
acquiring a current time from a clock timing application;
determining a current environment state within a vicinity of the intelligent device based on sensor information received from an environmental sensor;
determining a running time for operating the intelligent device to adjust the current environment state to a first target environment state by a target time; and
controlling operation of the intelligent device to achieve the first target environment state based on the current time, the running time, and the target time.

2. The method of claim 1, wherein controlling operation of the intelligent device based on the current time, the running time, and the target time comprises:
obtaining a predicted time by adding the running time to the current time; and
controlling operation of the intelligent device based on the predicted time and the target time.

3. The method of claim 2, wherein controlling operation of the intelligent device based on the predicted time and the target time comprises:
controlling operation of the intelligent device when the predicted time is the same as the target time; or
determining a first difference value between the target time and the predicted time, and controlling operation of the intelligent device when the first difference value is less than a first specified time.

4. The method of claim 1, further comprising:
prior to determining a running time required to adjust the current environment state to a first target environment state:
accessing a database storing a plurality of historical environment states, the plurality of historical environment states corresponding to environment states previously achieved by the intelligent device operating to adjust an environment state;
selecting at least one valid environment state from the plurality of historical environment states;
determining a first weighted value for the at least one valid environment state; and
setting the first weighted value as the first target environment state.

5. The method of claim 4, wherein determining the first weighted value for the at least one valid environment state comprises:
acquiring a first historical date for the at least one valid environment state, respectively, to obtain at least one first historical date, the first historical date being a date on which an environment state was previously adjusted to the valid environment state by the intelligent device;
determining at least one first weight using a specified function based on the at least one first historical date; and
calculating the first weighted value for the at least one valid environment state based on the at least one first weight.

6. The method of claim 4, further comprising:
receiving a first updating instruction, the first updating instruction carrying a second target environment state; and
updating the plurality of historical environment states based on the second target environment state.

7. The method of claim 6, wherein updating the plurality of historical environment states based on the second target environment state comprises:
acquiring a second historical date for the plurality of historical environment states, respectively, the second historical date being a date on which an environment state was previously adjusted to the historical environment states by the intelligent device;
selecting from the plurality of historical environment states a historical environment state having an earliest second historical date; and
replacing the selected historical environment state with the second target environment state.

8. The method of claim 1, further comprising:
prior to determining a running time required to adjust the current environment state to a first target environment state:
selecting at least one valid time from a plurality of historical times, the historical times corresponding to times the intelligent device has been previously controlled to adjust an environment state;
determining a second weighted value for the at least one valid time; and
setting the second weighted value as the target time.

9. The method of claim 8, wherein determining the second weighted value for the at least one valid time comprises:
acquiring a third historical date for the at least one valid time respectively to obtain at least one third historical date, the third historical date corresponding to a date for controlling the intelligent device at the valid time;
determining at least one second weight using a specified function based on the at least one third historical date; and
calculating a second weighted value for the at least one valid time based on the at least one second weight.

10. The method of claim 8, further comprising:
acquiring, upon receiving a second updating instruction, a receiving time for receiving the second updating instruction; and
updating the plurality of the historical times based on the receiving time.

11. The method of claim 10, wherein updating the plurality of the historical times based on the receiving time comprises:
acquiring a fourth historical date for the plurality of historical times respectively, the fourth historical date corresponding to a date for controlling the intelligent device at the historical times;
selecting from the plurality of historical times a historical time having an earliest fourth historical date; and
replacing the selected historical time with the receiving time.

12. A device for controlling an intelligent device, comprising:
a processor;
a memory for storing processor-executable instructions;
wherein the processor is configured to execute the processor-executable instructions to:
acquire a current time from a clock timing application;
determine a current environment state within a vicinity of the intelligent device based on sensor information received from an environmental sensor sensed from an environmental sensor;
determine a running time for operating the intelligent device to adjust the current environment state to a first target environment state by a target time; and
control operation of the intelligent device based on the current time, the running time, and the target time.

13. The device of claim 12, wherein the processor is further configured to execute the processor-executable instructions to:
obtain a predicted time by adding the running time to the current time; and
control operation of the intelligent device based on the predicted time and the target time.

14. The device of claim 13, wherein the processor is further configured to execute the processor-executable instructions to:
control operation of the intelligent device when the predicted time is the same as the target time; or
determine a first difference value between the target time and the predicted time, and control operation of the intelligent device when the first difference value is less than a first specified time.

15. The device of claim 12, wherein the processor is further configured to execute the processor-executable instructions to:
access a database storing a plurality of historical environment states, the plurality of historical environment states corresponding to environment states previously achieved by the intelligent device operating to adjust an environment state;
select at least one valid environment state from the plurality of historical environment states;
determine a first weighted value for the at least one valid environment state; and
set the first weighted value as the first target environment state.

16. The device of claim 15, wherein the processor is further configured to execute the processor-executable instructions to:
acquire a first historical date for the at least one valid environment state respectively to obtain at least one first historical date, the first historical date being a date on which an environment state was previously adjusted to the valid environment state by the intelligent device;
determine at least one first weight using a specified function based on the at least one first historical date; and
calculate the first weighted value for the at least one valid environment state based on the at least one first weight.

17. The device of claim 15, wherein the processor is further configured to execute the processor-executable instructions to:
receive a first updating instruction, the first updating instruction carrying a second target environment state; and
update the plurality of historical environment states based on the second target environment state.

18. The device of claim 12, wherein the processor is further configured to execute the processor-executable instructions to:
select at least one valid time from a plurality of historical times, the historical times corresponding to times the intelligent device has been previously controlled to adjust an environment state;
determine a second weighted value for the at least one valid time; and
setting the second weighted value as the target time.

19. The device of claim 18, wherein the processor is further configured to execute the processor-executable instructions to:
acquire, upon receiving the second updating instruction, a receiving time for receiving a second updating instruction; and
update the plurality of the historical times based on the receiving time.

20. A non-transitory computer-readable storage medium having stored therein instructions that, when executed by a processor of a controller device, causes the controller device to perform a method for controlling an intelligent device, the method comprising:
acquiring a current time from a clock timing application;
determining a current environment state within a vicinity of the intelligent device based on sensor information received from an environmental sensor;
determining a running time for operating the intelligent device to adjust the current environment state to a first target environment state by a target time; and
controlling operation of the intelligent device to achieve the first target environment state based on the current time, the running time, and the target time.
